(19) United States
(12) Patent Application Publication
(10) Pub. No.: US 2018/0075464 A1
(43) Pub. Date: Mar. 15, 2018

(54) Method and arrangement for assisting in decision making by utilizing personal profiling

(71) Applicant: ZEF Oy, Oulu (FI)

(72) Inventors: Jaakko Alasaarela, Oulu (FI); Markku Alasaarela, Oulu (FI); Juha Koskela, Oulu (FI)

(73) Assignee: ZEF Oy, Oulu (FI)

(21) Appl. No.: 15/263,712

(22) Filed: Sep. 13, 2016

(51) Int. Cl. G06Q 30/02; H04L 29/08

(52) U.S. Cl. CPC G06Q 30/0203; H04L 67/10

(57) ABSTRACT

The invention relates to a pre-meeting survey method configured to assist a customer in a decision making situation. The invention relates also to a data network arrangement, a server, and a computer program product, by means of which a pre-meeting survey is accomplished in a communications network before a booked customer meeting. The pre-meeting survey comprises a questionnaire that includes questions about well-known personality features of people and also about actual customer needs. The customer stores the answers to the questions of the pre-meeting survey in the server of the service or product provider. The server defines a personality profile of the customer by utilizing answers to the personality feature questions. On the basis of the defined personality profile of the customer the server further prepares a customer-personified agenda and customer-personified helpful contents to be utilized in the upcoming meeting.

### FIELD OF THE INVENTION

The invention relates to a system assisting a person or a customer in a decision making process, a data network arrangement utilized in the assisting system, and a method utilized the assisting system. The invention also relates to a server utilized in the data network arrangement and a computer program product to be utilized in the server.

### BACKGROUND

An example of a decision making situation is a traditional sales model, i.e. the sales model where the sales representative and customers meet face-to-face. The sales representative books a meeting with the customer for example over the phone, usually for within the upcoming two-week period. The phone call is often short and the goal of the call is only to book a sales meeting. After booking the sales meeting, the sales representative may send the customer a calendar invitation and a confirmation email.

After that, nothing usually happens before the meeting takes place. The sales representative is prepared for the meeting, while the customer may need to think over what the meeting was about. A talented sales representative takes over the situation in the meeting and starts to build a relationship with the customer. The sales representative often has a long list of questions that he or she systematically goes through in order to map needs of the customer. Usually the first meeting between the sales representative and the potential customer focuses only on two activities, chatting and mapping customer needs.

When the meeting is coming to an end, the aim for the sales representative is to schedule a second meeting where he or she offers a solution to one or more problems of the customer.

However, in the second meeting, the participants may have changed and once again a lot of time is spent on chatting and getting to know the needs of the customer.

After the relationships have been built, the sales representative finally gets a chance to present the solution that satisfies the needs of the customer. The sales representative and the participants go through the proposal and if the customer finds the proposed solution worthwhile, a deal can be closed.

However, this often requires an additional third meeting. If the customer meets several service providers, the buying process can be extremely painful for the customer.

Another significant change in a sales or buying process is that several people from the company may be involved in the decision making process. Therefore, it is important to invite an extensive crowd of participants to sales meetings and assist them in the decision making process by delivering them appropriate material in advance.

Also digitalization has reshaped buying behavior of the customers. A customer sits in the driver's seat and has taken over sales processes. As a consequence sales representatives or customer servants should focus on understanding the new reshaped buying process. In this process, instead of spending time in a sales meeting, the customers start their buying journey by searching for information online before even contacting a sales representative.

In the online information searching phase, the customer may for example utilize the so-called graphical comparator for comparison of services or products of possible service providers. The comparison target of the customer may be for example a product, a service, a travel destination, a person etc. The purpose of the comparison is to help the customer to make a decision which best fulfils the needs and desires of the customer performing the comparison with regard to the properties used in the comparison.

The above-mentioned online comparison system is generally called a comparator. The comparator may comprise different kinds of graphical evaluation means. Some examples of the graphical evaluation means are a one-dimensional evaluation line or a two-dimensional fourfold.

FIG. 1a shows a one-dimensional evaluation line 1 and an opinion/evaluation 2 presented by a user about an evaluation statement. In the example of FIG. 1a the left end of the one-dimensional evaluation line 1 illustrates a situation, where the comparator user may express that a feature is not important for the customer. The right end of the one-dimensional evaluation line 1 in FIG. 1a illustrates a situation, where the comparator user thinks that the feature under consideration is important for the customer.

The evaluation given by the comparator user regarding a presented statement can be compared to corresponding evaluation results of other service or product providers. Thus, by means of the comparator it is possible to calculate a congruency between the needs of the customer and the features of the services or products available from different service providers.

In addition to a one-dimensional evaluation line, the comparator can also utilize a two-dimensional fourfold of FIG. 1b. An example of a two-dimensional comparator is depicted in U.S. Pat. No. 7693743.

A single question fourfold of the comparator consists of two different properties of a feature to be examined. The features under consideration are set perpendicularly against each other in the displayed fourfold. The properties to be compared with the help of the question fourfold are usually in some way related to each other. In the question fourfold, each property may be described for example with numerical values 0-100%. Alternatively, the properties to be compared can be described with word pairs, e.g. disagree [symbol] agree, bad [symbol] good, or unimportant [symbol] important.

FIG. 1b shows a principled model of a question fourfold 3 to be utilized in the comparator. The user of the question fourfold steplessly moves a response cursor 4 to a desired point in the question fourfold 3. This possibility of aiming steplessly has been illustrated with four arrows pointing out from the cursor 4. When the user thinks that the response cursor 4 is in a point which corresponds to his or her opinion or evaluation with regard to the two properties of the feature shown in the fourfold, the user locks the response cursor 4 with a function related to the data processing device he or she uses.

In the examples of FIG. 1b at the horizontal left edge of the question fourfold it is expressed that the evaluated feature is not important. At the horizontal right edge of the question fourfold it is expressed that the evaluated feature is important. Correspondingly, at the vertical lower edge of the question fourfold it is expressed that the evaluated feature is cheap, and at the higher top edge of the question fourfold it is expressed that the evaluated feature is expensive.

A person using the two-dimensional comparator can see two properties of the comparison target, one on the horizontal axis and one on the vertical axis. Generally the ends of the axes of the question fourfold may describe opposite pairs of the same property. By using the two opposite pairs included in the question fourfold the comparator user can present his own evaluation of both of the examined properties by placing one evaluation point in a selected spot in the fourfold.

### SUMMARY OF THE INVENTION

An object of the invention is to present a method, a software application, a system, and a server for assisting a person or a customer in a decision making process by utilizing a pre-meeting survey in a data network arrangement.

The objects of the invention are attained with a pre-meeting survey method and arrangement where at first the customer needs and personal characteristics of the customer are defined via a pre-meeting questionnaire. In the pre-meeting survey according to the invention a customer stores his or her answers to the questions of the questionnaire to a server of the service or product provider. The server executes application software according to the invention that defines from the answers of the customer the personality profile of the customer by which the server creates a personified meeting agenda and selects personified helpful contents to be presented to the customer after the customer has answered the questionnaire. The application software has modified both the agenda and the selected helpful contents to fit the defined personal profile characteristics of the customer. The server sends the customer-personified agenda and selected helpful material to the customer so that the customer has time to become aware of the services or products before the agreed meeting and contemplate the services or products that the service or product provider can offer.

An advantage of the invention is that a pre-meeting profiling survey can decrease the average decision making cycle duration considerably for example in a sales process.

A further advantage of the invention is that a person, for example a customer does not lose a sense of control during the pre-meeting survey process and the person is well prepared for an upcoming decision making meeting.

A further advantage of the invention is that the person feels better equipped and well prepared in the decision making meeting when he or she is provided also with personified material or information concerning the decision making situation during the pre-meeting survey.

An advantage of the invention is additionally that the pre-meeting profiling survey simplifies the process by gathering information also on the personality and interests of the person. This personality knowledge enables for example a sales representative to prepare and present already in a first sales meeting to the customer a proposal for a decision to be made in a format that the person prefers.

The method for assisting a customer in a decision making situation according to the invention is characterized in that the method comprises:
defining of at least two basic personality profiles for customers by the service provider;
storing the created basic personality profiles into a database of a server of the service provider;
creating separate helpful contents related to the services or products of the service provider which helpful contents are based on typical customer needs of the basic personality profiles;
storing the created helpful contents into the database of the server;
proposing a meeting to a customer;
before an agreed customer meeting, the server of the service provider sends over a communication network a profiling questionnaire to a data processing apparatus of the customer, the questionnaire comprising questions, each including an evaluation line, about customer needs and personality characteristics of the customer;
the customer answers the questions of the questionnaire by placing an answer point on an evaluation line of each question on a webpage of the service provider by utilizing a graphic user interface of the data processing apparatus;
the data processing apparatus of the customer stores the answers of the customer to the questionnaire into the database of the server;
a processor of the server utilizes a profiling application installed in a memory of the server to classify the customer to one basic personality profile based on the received answers of the customer to the personality characteristics questions of the questionnaire;
by utilizing the profiling application, the processor of the server creates an agenda for the agreed customer meeting based on the answers to the personality characteristics questions and to the customer need questions;
the processor of the server selects presentation material from the helpful contents for the agreed customer meeting based on the answers to the customer need questions and the personality characteristics questions;
the processor of the server sends the created agenda and the selected presentation material at least to a sales representative of the service provider, and wherein;
in a personified customer meeting the sales representative of the service provider utilizes the defined customer meeting agenda and the customer profile based presentation material that assists the customer in making a decision.

The data network arrangement for assisting a customer in a decision making process according to the invention is characterized in that it comprises:
a communications network;
data processing apparatuses of customers connected to the communications network;
a server of a service or product provider comprising a processor unit, memory unit, input and output means, the server comprising:
   several customer input and output interfaces;
   several sales representative input and output interfaces;
   a database, and;
   computer program code configured, with the processor and the memory of the server, to cause the server at least to:
      store created basic personality profiles of customers into a database of the server;
      store into the memory the created helpful contents that are selected on the grounds of typical customer needs of the basic personality profiles;
      send over a communication network a profiling questionnaire to a data processing apparatus of the customer, the questionnaire comprising questions, each including an evaluation line, about customer needs and personality characteristics of the customer;
      store the answers of the customer to the questionnaire into the memory of the server;
      utilize a profiling application installed in the memory to classify the customer to one basic personality profile based on received answers of the customer to the personality characteristics questions of the questionnaire;
      create by utilizing the profiling application an agenda for the customer meeting based on the answers to the personality characteristics questions and to the customer need questions;
      select presentation material from the helpful contents for the agreed customer meeting based on the answers to the customer need questions and the personality characteristics questions, and
      send the created agenda and the selected presentation material at least to a sales representative of the service provider.

The server configured to assist a customer in a decision making process in a customer meeting by creating a customer-personified meeting agenda and selecting helpful contents related to services or products for the customer meeting according to the invention is characterized in that it comprises:
a processor unit;
a memory unit;
input and output means, and;
a user interface;
   the processor unit and the memory unit being at least configured to:
      store the created basic personality profiles of customers into a database of the server of the service provider;
      store into the memory the created helpful contents that are selected on the grounds of typical customer needs of the basic personality profiles;
      send over a communication network a profiling questionnaire to a data processing apparatus of a customer, the questionnaire comprising questions, each including an evaluation line, about customer needs and personality characteristics of the customer;
      store the answers of the customer to the questionnaire into the memory of the server;
      utilize a profiling application installed in the memory to classify the customer to one basic personality profile based on the received answers of the customer to the personality characteristics questions of the questionnaire;
      create by utilizing the profiling application an agenda for the agreed customer meeting based on the answers to the personality characteristics questions and to the customer need questions;
      select presentation material from the helpful contents for the agreed customer meeting based on the answers to the customer need questions and the personality characteristics questions, and
      send the created agenda and the selected presentation material at least to a sales representative of the service provider.

The non-transitory computer-readable medium with computer executable instructions stored thereon executed by a processor to perform the method of assisting a decision making process of a customer in an agreed customer meeting according to the invention is characterized in that it comprises:
defining at least two basic personality profiles for customers;
storing the created basic personality profiles into a database of a server;
creating separate helpful contents related to services or products of a service provider that are based on typical customer needs of the basic personality profiles;
storing the created helpful contents into the database of the server;
sending over a communication network a profiling questionnaire to a data processing apparatus of the customer, the questionnaire comprising questions, each including an evaluation line, about customer needs and personality characteristics of the customer;
receiving answers of the customer to the questions of the questionnaire from the data processing apparatus of the customer;
storing the answers of the customer to the questionnaire into the database of the server;
utilizing a profiling application installed in a memory of the server to classify the customer to one basic personality profile based on the received answers of the customer to the personality characteristics questions of the questionnaire;
creating by utilizing the profiling application an agenda for the agreed customer meeting based on the answers to the personality characteristics questions and to the customer need questions;
selecting helpful contents for the agreed customer meeting based on the answers to the customer need questions and the personality characteristics questions, and;
sending the created agenda and the selected presentation material at least to a sales representative of the service provider.

Some advantageous embodiments of the invention are presented in the dependent claims.

The basic idea of the invention is the following: We as human beings are very different in character. This is why it is not wise to serve every person in the same way. It can be that one person is very much into growing their revenue and another is into developing better customer experiences. These two exemplary persons should be treated in a different way. If for example a sales representative does not take that into consideration, the sales representative might lose a sale.

One example of a decision making situation is a sales meeting. The pre-meeting survey according to the invention helps a sales representative and a buyer to prepare for the upcoming sales meeting. The inventive pre-meeting survey method and arrangement is below depicted in connection with a sales meeting.

The personal characteristics of a buyer in a sales case can be taken into account by utilizing a pre-meeting survey method and arrangement according to the invention. A pre-meeting survey according to the invention is accomplished in the pre-meeting survey arrangement by utilizing a server of the service or product provider. The server is connected to the Internet. Also the buyer can establish a communication connection to the server of the pre-meeting survey arrangement via the Internet.

Before a decision making situation, for example before a booked sales meeting, a buyer gets an e-mail from the sales representative. The e-mail includes a link to a pre-meeting survey comprising a questionnaire that includes also questions about well-known personality features of people. The personal profile of the buyer is defined from the answers of the buyer to these questions. Based on the defined personal profile the server selects helpful content or information for the booked sales meeting. The buyer gets a confirmation from the server about an agreed meeting, the defined helpful content, and also an agenda of the meeting. The confirmation discloses advantageously also a link to the pre-meeting survey results.

The pre-meeting questionnaire consists advantageously also questions by which it is possible to observe how and when the buyer normally makes his or her decision. During answering to the questions the buyer is at the same time encouraged to familiarize beforehand with the topic or theme of the decision to be made in the booked meeting. This increases his or her level of engagement. The buyer feels that he or she is better equipped in the actual decision situation when he or she is beforehand provided with personified information material according to his or her interests.

By utilizing the pre-meeting survey the sales representative draws the buyer into a conversation before the first actual sales meeting. The sales representative can prepare the buyer for the upcoming sales meeting and guide him or her forward in the buying process. In the decision making method according to the invention the customer does not lose his or her sense of control although the process is pre-planned.

Knowing the personality characteristics of the buyer helps the sales representative to treat different kinds of buyers. The personal profile of the buyer advantageously includes personality traits, behavior, interests, and values. When the personal profile of a buyer is known, the sales representative knows what type of a customer he or she is. In that case the sales representative also knows the best way to make a proposal to him or her.

For the sales representative, the pre-meeting profiling survey according to the invention simplifies the process of gathering information about the interests, present state, and personality of the buyer. The survey enables the sales representative to prepare a proposal that is advantageously presented to the buyer already in the first sales meeting. Before the first sales meeting the server of the decision making arrangement according to the invention advantageously sends a personified agenda and material or information also to the buyer. This helps the buyer to be so well prepared that he or she is capable of making a decision already in the first sales meeting.

During the first sales meeting the sales representative may advantageously further define the sales proposal together with the buyer because he or she has been familiarized with the items of first sales proposal already.

When the buyer is engaged and well prepared, a conventional sales pitch is advantageously not needed in the first sales meeting at all. The sales representative needs to have the skills to crack challenges of the buyer and encourage the buyer to observe different viewpoints. Therefore already the first sales meeting is rewarding and beneficial for the buyer. Above-depicted activities lead to a superior buying experience as well as shortened sales cycle durations.

The computer program that is utilized to implement the pre-meeting survey method steps resides on a server of the service or product provider. The computer program advantageously classifies each buyer into one personality profile on grounds of the answers of the buyer to questions of the pre-meeting survey depicting personality features of people. On the basis of the defined personality profile of the buyer the server prepares an agenda for the upcoming sales meeting. The computer program is also configured to define and select helpful content that the server advantageously sends to the buyer when the buyer has answered to all the questions of the pre-meeting survey.

The functions of the pre-survey method can also be implemented as a so-called cloud service, also called cloud computing. In the cloud computing service the program execution is spread out and outsourced to cloud computing service providers that are operating in the data network. Cloud computing may occur for example on the Internet. The buyer only sees the agenda and helpful content just like in a direct connection with the server of the service or product provider.

### SHORT DESCRIPTION OF THE DRAWINGS

In the following, the invention will be described in detail. In the description, reference is made to the enclosed drawings, in which

FIG. 1a shows as an example a one-dimensional evaluation line known in the art;

FIG. 1b shows as an example a question fourfold known in the art;

FIG. 2a shows as an example a decision assisting arrangement according to the invention;

FIG. 2b shows as an example a server utilized in the implementation of the decision assisting arrangement according to the invention;

FIG. 3a shows two exemplary questions that may be utilized to create a personal profile of a person in the decision making arrangement according to the invention;

FIG. 3b shows an example depicting four personality profiles that may be utilized in the decision making arrangement according to the invention;

FIG. 3c shows a second example depicting four other personality profile characteristics that may be utilized in the decision making arrangement according to the invention;

FIG. 3d shows a third example depicting sixteen personality profile characteristics that may be utilized in the decision making arrangement according to the invention;

FIG. 4 shows as an exemplary block diagram the main functional components that are utilized in the decision making assisting arrangement process according to the invention;

FIG. 5a shows as an exemplary flow chart the operational main steps of the method assisting in decision making according to the invention; and

FIG. 5b shows as an exemplary flow chart a sending phase of an agenda.

### DESCRIPTION OF THE INVENTION

The embodiments in the following description are given as examples only and someone skilled in the art can carry out the basic idea of the invention also in some other way than what is described in the description. Though the description may refer to a certain embodiment or embodiments in several places, this does not mean that the reference would be directed towards only one described embodiment or that the described characteristic would be usable only in one described embodiment. The individual characteristics of two or more embodiments may be combined and new embodiments of the invention may thus be provided.

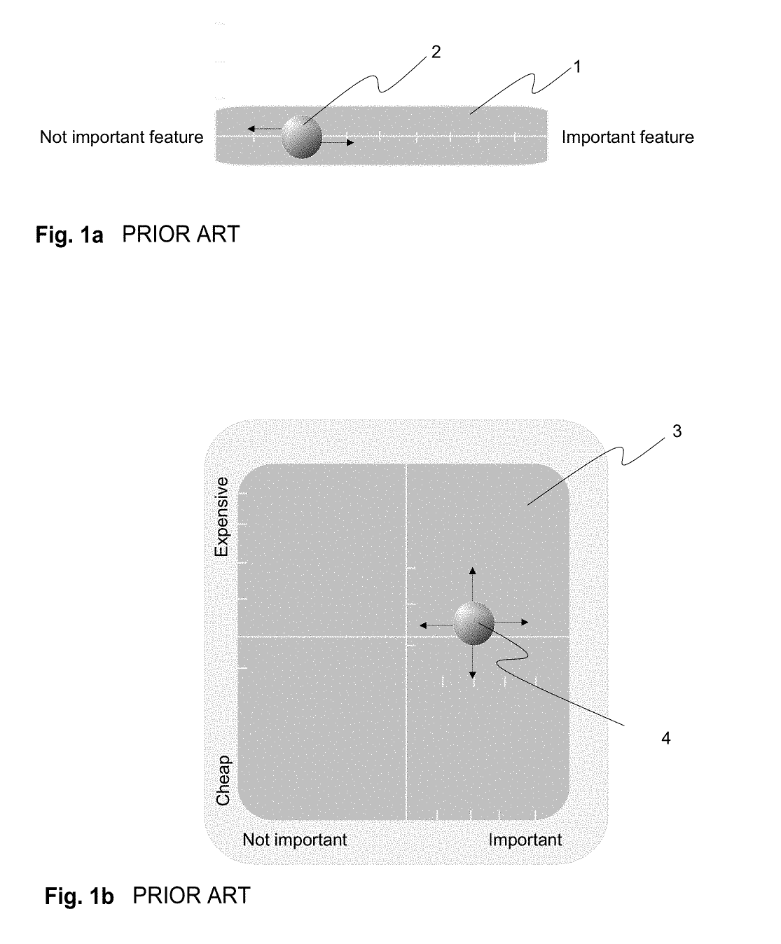

FIGS. 1a and 1b have been described in connection with the description of the prior art.

The method, pre-meeting survey, arrangement, server and software application according to the invention that are utilized in assisting a person in a decision making situation are depicted in detail below in the context of a sales case. The invention is not limited to the depicted sales case but it can be utilized in several other targets of applications where interaction takes place between persons having different personal characteristics.

Some examples where the invention may be utilized are a strategy process, decision making in an executive committee, a human resource management, surveys of service capability, a product evaluation, a service evaluation, an election machine, a risk evaluation, a quality evaluation, a workplace wellbeing study, a job attitude test, or indifferent kinds of meeting arrangements. By utilizing the inventive method persons being part of one of the above-mentioned interaction situations are well prepared to make decisions that are well advised in meetings the persons are involved in.

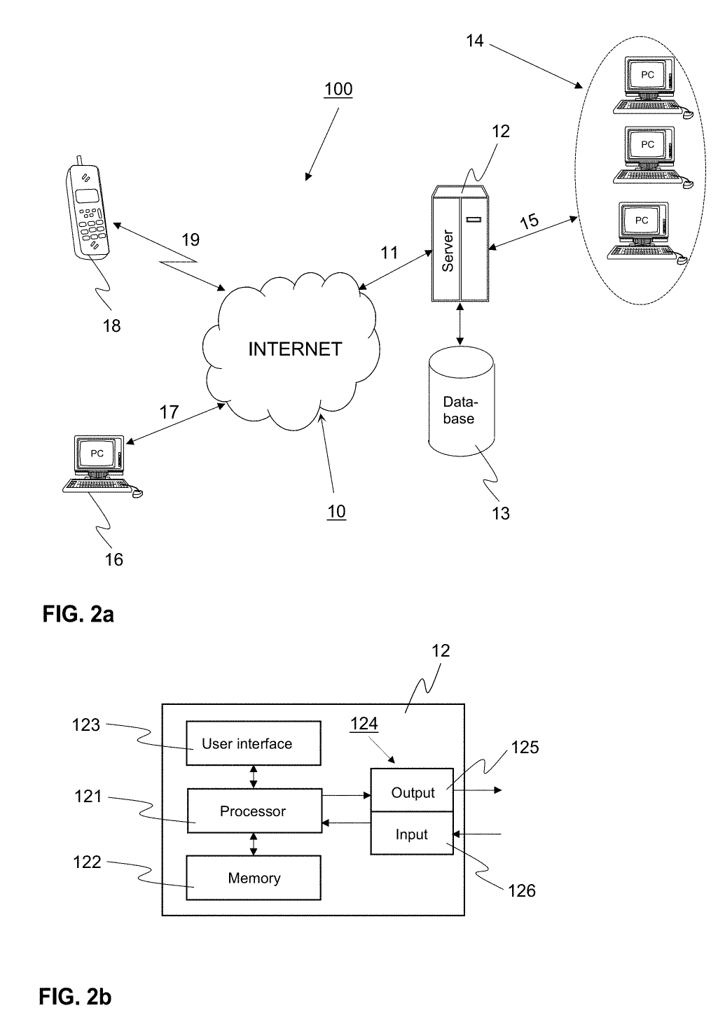

FIG. 2a shows exemplary main functional components that are utilized in the decision making arrangement 100 according to the invention where a buyer can be assisted in a decision making situation. Persons utilizing the decision making arrangement 100, which assist them in said decision making, are connected with their own data processing devices 16, 18 via the Internet 10 to a server 12 of a service or product provider. In the server 12 has been installed software that executes the main steps of a pre-meeting survey that is utilized in the decision making method according to the invention.

The sales representative and a buyer book a meeting. After that the buyer gets an e-mail from the sales representative. The e-mail includes a web link by which the buyer can establish a connection to the server 12 of the service or product provider and answer to a questionnaire of a pre-meeting survey according to the invention that the server 12 has opened on the user interface of the data processing device 16 or 18 of the buyer.

FIG. 2a shows two exemplary data processing devices 16 and 18, which an individual can utilize. Reference 16 shows a conventional computer, which is connected to the Internet 10 via a fixed data communication connection 17. Reference 18 shows as an example a wireless data processing device connecting to the Internet via a wireless data transfer connection 19. The wirelessly functioning data processing device 18 can be for example a cellular network terminal such as a mobile phone, a palmtop computer, or a portable computer equipped with a WLAN feature.

When the buyer wants to utilize the decision making arrangement 100 that assists in the decision making, he or she opens a questionnaire on a webpage of on the server 12 with the data processing device 16 or 18. The buyer gives answers to the questions of the questionnaire by using a graphic user interface created by server 12 that opens on the screen of the data processing device 16 or 18. The utilized user interface in the questionnaire may advantageously be a comparison line or a question fourfold. The decision making arrangement may advantageously simultaneously utilize a comparison line, question fourfold and also selection questions. Each individual question, comparison line, fourfold, or selection question opens up in the decision making arrangement 100 as a new webpage.

Questions in the questionnaire comprise at least two types of questions. The first question type may advantageously comprise questions asking personal characteristics of the person who has to make a decision.

The second question type may comprise questions for example about technical, economic, social, or environmental features of a service, product, or system about which the person has to make a decision.

The server 12, wherein the computer program implementing the method steps according to the invention is installed, is advantageously connected with a fixed data transfer connection 11 to the Internet 10.

Reference 14 shows data processing devices used by the customer sales representatives of one service or product provider. When the sales representative has booked a meeting with a buyer, the sales representative sends from his own data processing device 14 an e-mail to the data processing device 16 or 18 of the customer, which e-mail includes a web link to the questionnaire of the pre-meeting survey according to the invention.

FIG. 2b shows the operational main parts of the server 12 utilized in the implementation of the decision making arrangement 100 according to the invention. The server 12 comprises a processor or processor means 121, which advantageously comprise an arithmetic logic unit, a number of different registers and control circuits. A data storing arrangement 122, such as memory unit or memory means, whereon computer-readable information, programs or user data can be stored, has been connected to the processor means 121. The memory means 122 typically contain memory units, which allow both reading and writing functions (Random Access Memory, RAM), and memory units containing non-volatile memory, from which data can only be read (Read Only Memory, ROM).

The server 12 also comprises an interface element 124, which comprises an input or input means 126 for receiving data from the data processing devices 16, 18 of the customers via a data communications network 10, from the data processing devices 14 of the sales representatives or from a separate database device 13. The data received with the input means 126 is advantageously transferred to be processed by the processor means 121 of the server 12.

The interface element 124 of the server 12 also comprises an output or output means 125, with which data is transferred from the processor means of the server 12 either to a data transfer network 10 and from there to the data processing device 16 and 18 of the customer, to the database device 13, or to data processing devices 14 of the sales representatives.

The server 12 advantageously also comprises a user interface 123, which comprises means for receiving data and/or control commands from the user of the server 12. The user interface 123 can for example comprise a keyboard, a touch screen, a microphone, and a speaker.

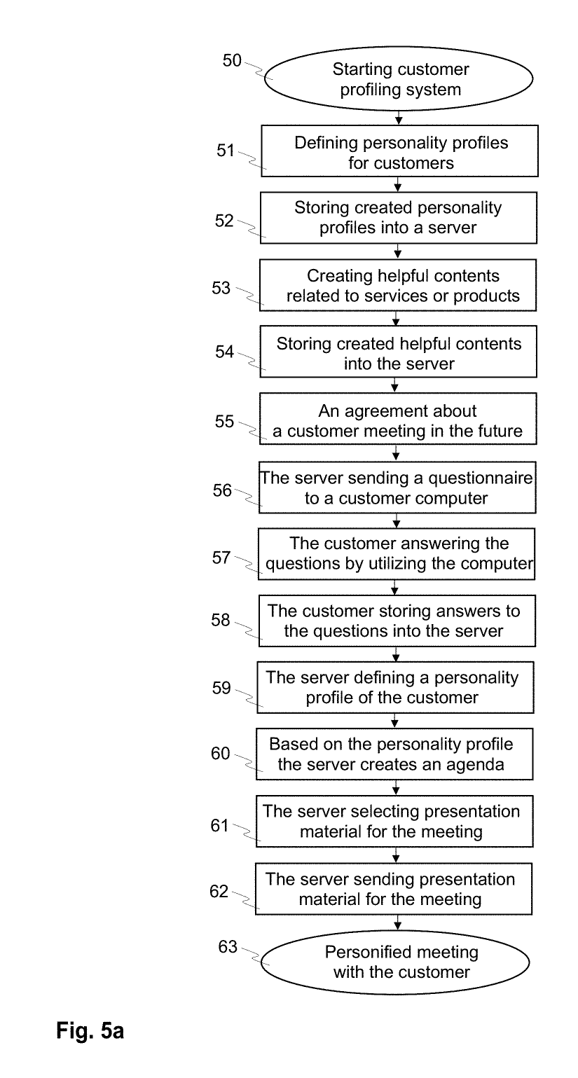

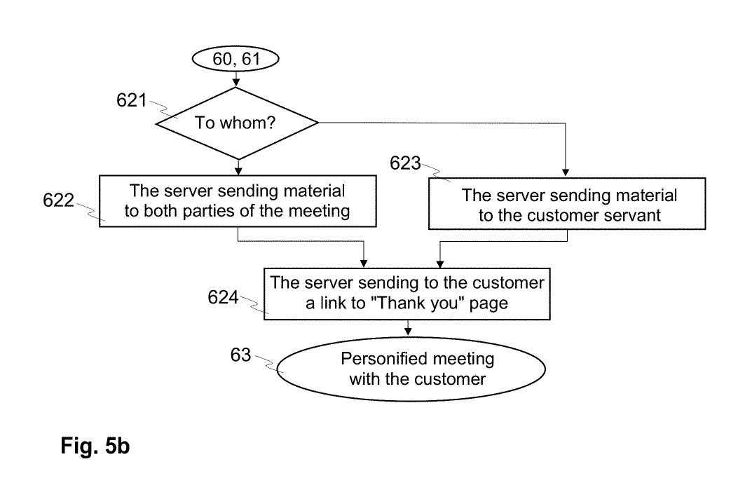

The processor means 121, the memory means 122, the interface element 124, and the user interface 123 are electrically connected together to systematically execute received and/or stored data or information in accordance with predetermined and substantially pre-programmed operational sequences. Such operational sequences also include the operational sequences described in connection to FIGS. 5a and 5b, which implement the functions of the decision making method according to the invention.

The detailed implementation of the logical units of the server in FIG. 2b is prior art to someone skilled in the art.

It is obvious to someone skilled in the art that the functions of the decision making method can advantageously also be implemented as a so-called cloud service or cloud computing. In this embodiment the customer is not aware of using a spread-out service, because the use experience corresponds to the view of a locally produced decision making system. The customer user only sees the interface, just as in the embodiment where the decision making system is implemented in a server administered by the service or product provider.

The number of questions, such as evaluation lines and/or question fourfolds, included in a questionnaire of the pre-meeting survey in a certain decision making case depends on the subject matter about which the decision has to be made. The number of questions being evaluated and the preciseness of the results striven for in the decision making are thus taken into account. The larger the number of questions in the pre-meeting survey is, the more precise the result of the pre-meeting survey made will turn out to be.

When the person, for example a buyer, has given his or her own answers to all the questions of the pre-meeting survey, a personality profile of the buyer can be defined on the basis of the answers to the questions concerning well-known personality features of people. The buyer can thereafter be classified to one personality profile that is utilized in the decision making arrangement according to the invention. The sales representative now knows the character of the buyer and also knows how to prepare for the upcoming meeting with buyer-personified presentation material and buyer-personified agenda which the server 12 has defined from the answers of the customer.

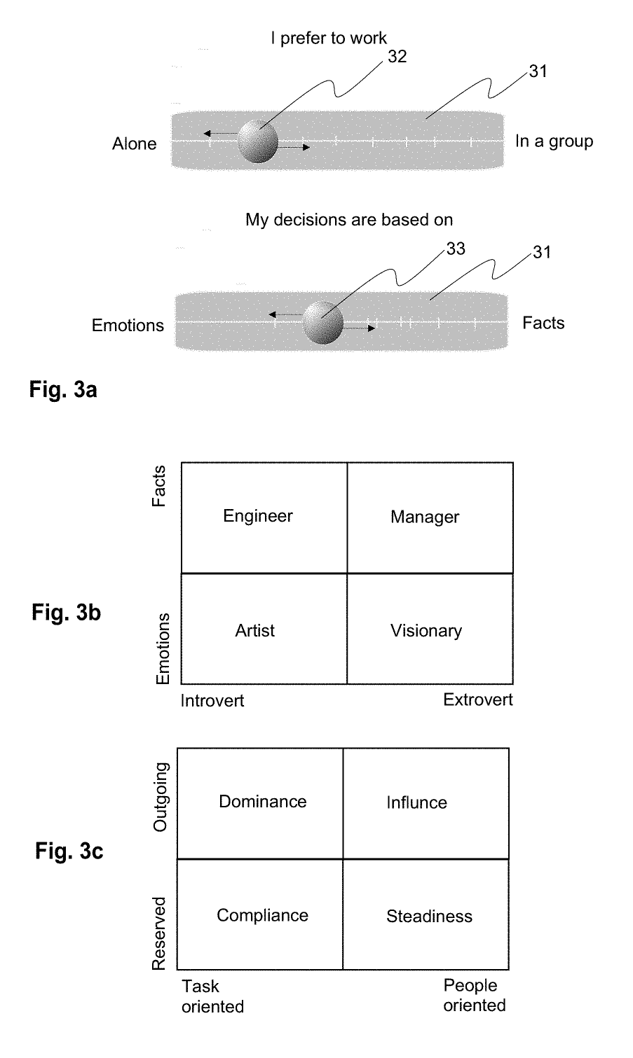

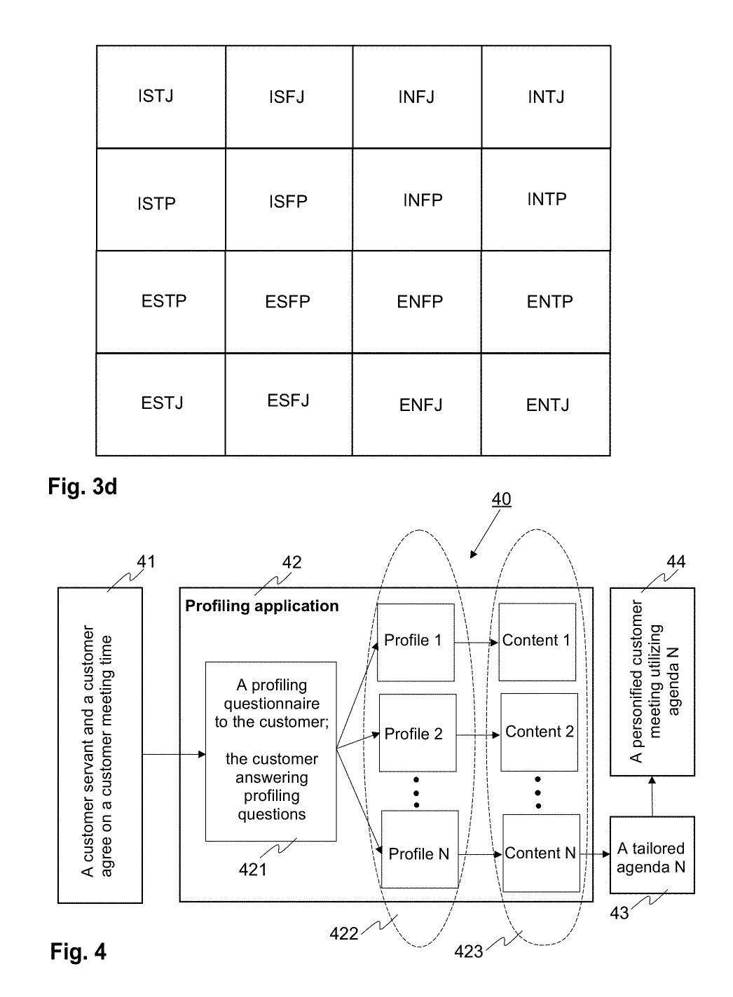

FIG. 3a shows two exemplary questions by which some personality characters of a person can be asked by utilizing one-dimensional question line 31. To the first exemplary question the person has given an answer 32 that he or she mostly works alone and also likes this situation. Questions like this attempt to find out how introvert or extrovert the person is.

To the second exemplary question the person has given an answer 33 that he or she bases his or her decision a little bit more on emotions than on facts. Questions like this attempt to find out what the person mostly bases his or her decisions on.

FIG. 3b shows an example how by utilizing answers to the two exemplary questions of FIG. 3a a person can be classified to one of four exemplary personalities. The exemplary personalities are a manager, a visionary, an artist, and an engineer.

A manager is an extrovert person who bases his or her decisions in most cases mainly on facts which concern an object of the decision.

A visionary is also an extrovert person but he or she bases his or her decisions more on emotions about an object of the decision.

An artist is an introvert person who bases his or her decision mainly on emotions about an object of the decision.

An engineer is an introvert person who bases his or her decision on facts about an object of the decision.

FIG. 3c shows an example of what kind of other characteristics a person that is classified in one of the personalities of FIG. 3b further may have.

Manager is often also a task oriented and dominant person who makes quick decisions.

Visionary is often also a people oriented and influential person who makes quick decisions.

Artist is often also a people oriented and emotional person who makes slow decisions.

Engineer is often also a task oriented and compliant person who makes slow decisions.

By utilizing a defined personality profile of the customer, for example a buyer, the decision making software installed to the server of the service or product provider is able to define a buyer-personified agenda and selects proper helpful content or material to be sent to the buyer after the buyer has answered to the questionnaire.

The buyer has during answering to the questions of the pre-meeting questionnaire increased his or her awareness of the case in question. That is what needs to be decided. When the buyer gets the personified agenda and helpful content offered, he or she also starts to consider possible alternatives for a solution in his or her mind.

A final decision of the person in a decision making case is 90 per cent based on these two thinking phases, awareness (60%) and consideration (30%), that precede the actual decision making situation that in the buying case is the meeting with the sales representative. Only 10 per cent of the final decision is based on discussions and actions in the actual decision phase, i.e. the sales meeting. Therefore the pre-meeting survey according to the invention can considerably increase the possibility that the buyer makes a sales decision already in the first sales meeting.

A personal profile that is utilized in pre-meeting survey making method according to the invention may be defined also less or more in detail than in the four personality profiles depicted above.

One possibility to define a personality profile is to utilize FFM model (Five Factor Model). The main features that are utilized in FFM model are: openness to experience, conscientiousness, extraversion, agreeableness, and neuroticism. In each of these profiles a person may have a value between values “high” and “low”. A person having a “high” value behaves differently than a person having a “low” value in the same basic personality feature. So when the FFM model is utilized in the decision making method according to the invention, there are ten different personality profiles that may be used in the pre-meeting survey for profiling the person in question.

Another different way to define a personality of a person is to utilize MBTI® personality inventory. In MBTI® inventory, it is possible to classify a person to one personality profile from sixteen personality profiles. The MBTI® profiles are depicted in FIG. 3d. The MBTI® profiles are based on the following basic personality features: favorite world, extraversion (E) or introversion (I); information, sensing (S) or intuition (N); decisions; thinking (T) or feeling (F), and structure; judging (J) or perceiving (P).

In FIG. 3d there are depicted sixteen possible combinations of these personality features by utilizing the above-mentioned capital letters.

FIG. 4 depicts an example block diagram 40 on how the customer, in the example of FIG. 4 a buyer, is assisted in decision making in an exemplary sales case.

In block 41 the sales representative of a service or product provider and the customer book a sales meeting. After the booking the sales representative sends an e-mail to the buyer that includes a web link to a pre-meeting survey according to the invention.

In block 42 it is depicted how a pre-meeting software application according to the invention advantageously residing in the server of the sales representative accomplishes automatically most of the next functional steps needed to profile and assist the customer in the decision making process that is based on the pre-meeting survey according to the invention. The pre-meeting software advantageously comprises two sub software applications. The first sub software application is utilized to define a personal profile of a person that has answered to the questions of the pre-meeting survey. The second sub software application is utilized in defining a personified agenda and selecting personified helpful contents based on the defined customer profile for the booked meeting.

In step 421 of the block 42 the buyer first gets from the sales representative the e-mail by which he or she can open a pre-meeting questionnaire on his or her data processing device. In the second step the buyer answers the questions of the questionnaire. The questionnaire comprises questions about the personality of the buyer and questions about service or product needs of the buyer.

In step 422 of the block 42 the profiling application in the server defines from the answers of the buyer to which one of the possible personal profiles 1-N the buyer fits best.

In step 423 of the block 42 the pre-meeting application in the server defines and selects proper helpful material content that suits the defined personal profile of the buyer best. In the same context the pre-meeting application creates also a buyer-personified agenda for the upcoming meeting.

In block 43 the buyer gets the personified agenda defined by the server and a web link to personified helpful content. The helpful content may be a datasheet of a product, a technical document, a picture, a brochure, a video, a webinar, an infographic, or a podcast.

Before the booked meeting the buyer can study the helpful content thoroughly when he or she is considering possible alternatives from which the he or she can select the best one to be discussed in the personified sales meeting in block 44.

FIG. 5a shows as an exemplary flowchart the main steps of a pre-meeting method according to the invention that may be utilized for assisting a buyer in the decision making. Although the example of FIG. 5a depicts a sales process, the pre-meeting survey method according to the invention is not limited only to the depicted sales case.

In the pre-meeting survey method according to the invention information that is obtainable from a buyer's answers to questions included a pre-meeting survey is utilized for creating a customer-personified meeting agenda and also provides buyer-personified meeting material for the meeting.

Steps 50-54 of the pre-meeting survey method are advantageously executed when a pre-meeting survey according to the invention has been put to use in a company of the sales representative.

In step 50 the personality profile assessment tool that is possible to be utilized in pre-meeting survey according to the invention is activated in the company. In one advantageous embodiment the company may select one personality assessment tool from a group of suitable personality assessment tools to be utilized in the pre-meeting survey according to the invention.

After personality assessment tool selection in step 51 the personality profiles of the assessment tool may advantageously be further fine-tuned so that it suits well to the pre-meeting method according to the invention that has been taken into use in the company.

In step 52 the defined personality profiles are stored into a server of the service or product provider.

In step 53 the helpful contents that may be utilized in the context of services and products of the sales representative are created or selected. A distinct helpful material selection may be created for different services or products of the company. The created helpful contents may be a datasheet of a product, a technical document, a picture, a brochure, a video, a webinar, an infographic, a web link, or a podcast.

In step 54 the defined helpful contents are stored into a server of the service or product provider.

In step 55 the sales representative books a sales meeting with a buyer of a customer.

After a date has been booked for the meeting, in step 56 the sales representative sends from the server of the service or product provider an e-mail to the buyer of the customer. The e-mail comprises at least a link to a web page of the service or product provider. The web page includes an icon by which the buyer of the customer can open the pre-meeting survey according to the invention.

In step 57 the buyer answers the questions of the questionnaire. The questionnaire comprises questions about personal characteristics of the buyer and questions about the service or product needs of the company of the buyer.

In step 58 the buyer stores his or her answers to the questions of the questionnaire to the server of the service or product provider.

In step 59 the server defines the personal profile of the buyer that best fits him or her based on the answers that the buyer has given to the questions about personal characteristics. The server saves the defined personal profile of the buyer in a database of the server.

In step 60 the server creates a buyer-personified agenda for the agreed sales meeting. The agenda fits the behavior pattern of the defined personal profile of the buyer. This means that in the sales meeting the sales representative can guide the discussion in a way which does not irritate the buyer.

In step 61 the server selects proper helpful contents for the booked sales meeting. The material included in the helpful contents is selected based on the behavior pattern of the defined personal profile of the buyer and also the defined customer needs.

In step 62 the server sends the buyer-personified agenda and buyer-personified helpful material to the sales representative and advantageously also to the buyer of the customer.

The booked personified sales meeting takes place in step 63.

FIG. 5b shows as an exemplary flow chart the sub-functions included in step 62 of FIG. 5a.

After steps 60 and 61 it is examined in the server in a sub-step 621 to whom the buyer-personified agenda and buyer-personified helpful contents should be sent.

If the buyer-personified agenda and buyer-personified helpful contents should be sent only to the sales representative, the decision is made in sub-step 622.

If the buyer-personified agenda and buyer-personified helpful contents should be sent to the sales representative and the buyer, the decision is made in sub-step 623.

In both alternatives the process continues to sub-step 624 where the server sends a link to a “Thank you” page of the service or product provider to the buyer.

The content of that particular page helps the buyer of the customer to prepare for the upcoming meeting. The content should be the same kind of material that the sales representative will present during the booked sales meeting. The idea is that the sales representative does not need to tell much about the service or product during the booked sales meeting because the customers have already received that information before the booked sales meeting. The content of the thank you page advantageously comprises in different formats articles, videos, webinars, infographics, and podcast that are relevant and valuable to the buyer of the customer.

Some advantageous embodiments of the comparison method and comparator according to the invention have been described above. The invention is not limited to the solutions described above, but the inventive idea can be applied in numerous ways within the scope of the claims.

1. An improved computer-implemented method that assists in an agreed customer meeting a decision making process of a customer, the method comprising the steps of
a service provider defining at least two basic personality profiles for customers;
storing the created basic personality profiles into a database of a server of the service provider;
creating separate helpful contents related to the services or products of the service provider which helpful contents are based on typical customer needs of the basic personality profiles;
storing the created helpful contents into the database of the server;
proposing a meeting to a customer;
before an agreed customer meeting the server of the service provider sends over a communication network a profiling questionnaire to a data processing apparatus of the customer, the questionnaire comprising questions, each including an evaluation line, about customer needs and personality characteristics of the customer;
the customer answers the questions of the questionnaire by placing an answer point on an evaluation line of each question on a web page of the service provider by utilizing a graphic user interface of the data processing apparatus;
the data processing apparatus of the customer stores the answers of the customer to the questionnaire into the database of the server;
a processor of the server utilizes a profiling application installed in a memory of the server to classify the customer to one basic personality profile based on the received answers of the customer to the personality characteristics questions of the questionnaire;
the processor of the server creates by utilizing the profiling application an agenda for the agreed customer meeting based on the answers to the personality characteristics questions and to the customer need questions;
the processor of the server selects presentation material from the helpful contents for the agreed customer meeting based on the answers to the customer need questions and the personality characteristics questions;
the processor of the server sends the created agenda and the selected presentation material at least to a sales representative of the service provider, and wherein;
in a personified customer meeting the sales representative of the service provider utilizes the defined customer meeting agenda and the customer profile based presentation material that assists the customer in making a decision.

2. The computer-implemented method according to claim 1, wherein the processor of the server sends to the customer a web address from which the customer gets the personified meeting agenda, personified helpful contents, and the questionnaire results.

3. The computer-implemented method according to claim 2, wherein the web address further comprises a link at least to one of the following helpful contents: a datasheet of a product, a technical document, a picture, a brochure, a video, a webinar, an infographic, or a podcast.

4. The computer-implemented method according to claim 1, wherein the basic personality profiles are:
a manager whose personality profile includes characteristics defining the person to be an extrovert person who bases his or her decision on facts about a service or product;
a visionary whose personality profile includes characteristics defining the person to be an extrovert person who bases his or her decision on emotions about a service or product;
an artist whose personality profile includes characteristics defining the person to be an introvert person who bases his or her decision on emotions about a service or product, and;
an engineer whose personality profile includes characteristics defining the person to be an introvert person who bases his or her decision on facts about a service or product.

5. The computer-implemented method according to claim 4, wherein the basic personality profile of:
the manager further includes features depicting task orientation, dominance, and quick decision making;
the visionary further includes features depicting people orientation, influence, and quick decision making;
the artist further includes features depicting people orientation, feeling, and slow decision making, and;
the engineer further includes features depicting task orientation, compliance, and slow decision making.

6. A data network arrangement for assisting in a customer meeting a decision making process of a customer, comprising:
a communications network;
data processing apparatuses of customers connected to the communications network;
a server of a service or product provider comprising a processor unit, a memory unit, input and output means, the server comprising:
several customer input and output interfaces;
several sales representative input and output interfaces;
a database, and;
computer program code configured, with the processor and the memory of the server, to cause the server at least to:
store created basic personality profiles of customers into a database of the server;
store created helpful contents into the memory that are selected on the grounds of typical customer needs of the basic personality profiles;
send over a communication network a profiling questionnaire to a data processing apparatus of the customer, the questionnaire comprising questions, each including an evaluation line, about customer needs and personality characteristics of the customer;
store the answers of the customer to the questionnaire into the memory of the server;
utilize a profiling application installed in the memory to classify the customer to one basic personality profile based on the received answers of the customer to the personality characteristics questions of the questionnaire;
create by utilizing the profiling application an agenda for the customer meeting based on the answers to the personality characteristics questions and to the customer need questions;
select presentation material from the helpful contents for the agreed customer meeting based on the answers to the customer need questions and the personality characteristics questions, and
send the created agenda and the selected presentation material at least to a sales representative of the service provider.

7. The data network arrangement according to claim 6, wherein the processor of the server is further configured to send to the customer a web address from which the customer gets the personified meeting agenda, personified helpful contents, and the questionnaire results.

8. A server configured to assist in a decision making process in a customer meeting by creating a personified meeting agenda and to select personified helpful contents related to services or products for the customer meeting, the server comprising:
a processor unit;
a memory unit;
input and output means, and;
a user interface;
the processor unit and the memory unit are at least configured to:
store created basic personality profiles of customers into a database of the server of the service provider;
store created helpful contents into the memory that are selected on the grounds of typical customer needs of the basic personality profiles;
send over a communication network a profiling questionnaire to a data processing apparatus of a customer, the questionnaire comprising questions, each including an evaluation line, about customer needs and personality characteristics of the customer;
store the answers of the customer to the questionnaire into the memory of the server;
utilize a profiling application installed in the memory to classify the customer to one basic personality profile based on received answers of the customer to the personality characteristics questions of the questionnaire;
create by utilizing the profiling application an agenda for the agreed customer meeting based on the answers to the personality characteristics questions and to the customer need questions;
select presentation material from the helpful contents for the agreed customer meeting based on the answers to the customer need questions and the personality characteristics questions, and
send the created agenda and the selected presentation material at least to a sales representative of the service provider.

9. The server according to claim 8, wherein the processor of the server is further configured to send to the customer a web address from which the customer gets the personified meeting agenda, personified helpful material, and the questionnaire results.

10. The server according to claim 9, wherein the web address further comprises a link at least to one of the following helpful contents: a datasheet of a product, a technical document, a picture, a brochure, a video, a webinar, an infographic, or a podcast.

11. The server according to claim 8, wherein the server is configured to classify customers to basic personality profiles which are:
a manager whose personality profile includes characteristics defining the person to be an extrovert person that bases his or her decision on facts about a service or product;
a visionary whose personality profile includes characteristics defining the person to be an extrovert person that bases his or her decision on emotions about a service or product;
an artist whose personality profile includes characteristics defining the person to be an introvert person that bases his or her decision on emotions about a service or product, and;
an engineer whose personality profile includes characteristics defining the person to be an introvert person that bases his or her decision on facts about a service or product in a customer meeting.

12. The server according to claim 11, wherein the server is further configured to include in:
the manager personality profile features depicting task orientation, dominance, and quick decision making;
the visionary personality profile features depicting people orientation, influence, and quick decision making;
the artist personality profile features depicting people orientation, feeling, and slow decision making, and;
the engineer personality profile features depicting task orientation, compliance, and slow decision making.

13. A non-transitory computer-readable medium with computer executable instructions stored thereon executed by a processor to perform the method of assisting a decision making process of a customer in an agreed customer meeting, the method comprising:
defining at least two basic personality profiles for customers;
storing the created basic personality profiles into a database of a server;
creating separate helpful contents related to services or products of a service provider that are based on typical customer needs of the basic personality profiles;
storing the created helpful contents into the database of the server;
sending over a communication network a profiling questionnaire to a data processing apparatus of the customer, the questionnaire comprising questions, each including an evaluation line, about customer needs and personality characteristics of the customer;
receiving answers of the customer to the questions of the questionnaire from the data processing apparatus of the customer;
storing the answers of the customer to the questionnaire into the database of the server;
utilizing a profiling application installed in a memory of the server to classify the customer to one basic personality profile based on the received answers of the customer to the personality characteristics questions of the questionnaire;
creating by utilizing the profiling application an agenda for the agreed customer meeting based on the answers to the personality characteristics questions and to the customer need questions;
selecting helpful contents for the agreed customer meeting based on the answers to the customer need questions and the personality characteristics questions, and;
sending the created agenda and the selected presentation material at least to a sales representative of the service provider.

14. The non-transitory computer-readable medium according to claim 13, further comprising sending to the customer a web address from which the customer gets the personified meeting agenda, personified helpful material, and the questionnaire results.

15. The non-transitory computer-readable medium according to claim 14, wherein the web address further comprises a link at least to one of the following helpful contents: a datasheet of a product, a technical document, a picture, a brochure, a video, a webinar, an infographic, or a podcast.

16. The non-transitory computer-readable medium according to claim 13, further comprising:
including in a manager personality profile characteristics defining the person to be an extrovert person that bases his or her decision on facts about a service or product;
including in a visionary personality profile characteristics defining the person to be an extrovert person that bases his or her decision on emotions about a service or product;
including in an artist personality profile characteristics defining the person to be an introvert person that bases his or her decision on emotions about a service or product, and;
including in an engineer personality profile characteristics defining the person to be an introvert person that bases his or her decision on facts about a service or product.

17. The non-transitory computer-readable medium according to claim 16, further comprising:
including in the manager personality profile features depicting task orientation, dominance, and quick decision making;
including in the visionary personality profile features depicting people orientation, influence, and quick decision making;
including in the artist personality profile features depicting people orientation, feeling, and slow decision making, and;
including in the engineer personality profile features depicting task orientation, compliance, and slow decision making.
